(19) United States
(12) Patent Application Publication
(10) Pub. No.: US 2015/0174787 A1
(43) Pub. Date: Jun. 25, 2015

(54) METHOD FOR FORMING A FIRE RETARDANT-TREATED FIBER PRODUCT

(71) Applicant: BLH TECHNOLOGIES INC., Halifax (CA)

(72) Inventor: Daniel Baroux, Halifax (CA)

(21) Appl. No.: 14/639,557

(22) Filed: Mar. 5, 2015

Related U.S. Application Data
(63) Continuation of application No. PCT/CA2013/050675, filed on Sep. 3, 2013.
(60) Provisional application No. 61/697,365, filed on Sep. 6, 2012.

(51) Int. Cl. B27N 9/00; D21F 3/02

(52) U.S. Cl. CPC B27N 9/00; D21F 3/0209

(57) ABSTRACT

An apparatus and method for forming a fire retardant-treated fiber product is provided. A first nip is defined by a pair of juxtaposed processing members, and is configured to receive a fiber product therethrough. At least one of the processing members comprises an incisor member extending from a processing surface thereof, and interacting with and altering a surface of the fiber product directed through the first nip. A second nip is defined by a pair of juxtaposed compression members, and is configured to receive the fiber product therethrough. Compression surfaces of the compression members cooperate to compress the surface of the fiber product within an elastic range associated therewith. At least one of the first and second nip is arranged to receive a fire retarding solution such that the fiber product is interacted therewith at least upon entering the at least one of the first and second nip.

### BACKGROUND OF THE DISCLOSURE

1. Field of the Disclosure

Aspects of the present disclosure relate to fire retardant fiber products, and, more particularly, to a method and apparatus for forming a fire retardant-treated fiber product, and associated apparatus.

2. Description of Related Art

It may sometimes be desirable for particular cellulose or other fiber-based products to exhibit resistance to heat and flames, such as that resulting from an incidental fire, and/or to fire. In some instances, such a fiber-based product such as lumber may have a fire retardant product applied thereto, post-formation, to provide some fire resistance capabilities therefor. That is, an exemplary as-formed fiber-based product such as lumber may have a surface treatment, for example, a liquid fire retardant, applied thereto in order for the treated product to exhibit at least some fire resistance. Because the porosity of such fiber products may vary considerably, and since the application procedure may be uneven and inconsistent (i.e., may result in uneven and inconsistent coverage of the surfaces of the fiber product), such treatments may tend to remain on exposed surfaces of the fiber product and may not penetrate through the surface or become absorbed by the fiber product to any appreciable extent. As such, the result may often be an insignificant, if any, improvement in the fire or heat resistance characteristics of the fiber product. In those cases, the fiber product may pose a hazard in the event of a fire, which the product is intended to retard or otherwise provide some resistance to the flames an/or heat, to a similar extent as an untreated fiber product. Further, such treatment processes may not necessarily be efficient in terms of applying the fire retardant to the fiber-based product, may not include provisions for capturing or recycling excess portions of the fire retardant product, and may not have the capability for preventing or restricting losses of the fire retardant due, for instance, to evaporative processes.

Other techniques for treating such fiber products, such as a pressure treating process for wood preservation and/or for fire and/or heat resistance of the as-formed fiber product, may also be time consuming and inefficient, as well as possibly environmentally hazardous. Such pressure treatment systems and processes typically require, for example, a “pressure treatment vessel.” One shortcoming of such systems and processes may be, for instance, that each vessel may only be loaded with one charge, batch, or payload at a time of the fiber product to be treated. Moreover, each pressure treatment process per vessel may have a duration of, for example, 1 hour to 8 hours, depending on the treatment chemical being applied, as well as the desired performance of the treated fiber product (i.e., the desired performance may dictate the chemical application parameters). In addition, the length and/or width of the vessel may be limited and, in turn may thus limit the maximum dimensions (i.e., length and/or width) of the fiber product (i.e., lumber) to be treated. On the basis of such factors, the whole pressure treatment process may be time consuming and, as such, only a limited volume of the treated fiber product may be produced on a daily basis. Such a time consuming process may thereby increase costs and/or lower efficiency. In some instances, such pressure treatment systems and methods, since based on a batch process, may not necessarily properly or evenly treat the fiber product. For example, different species of lumber/timber can exhibit variances in surface tension or allowed penetration/absorption of the treatment chemicals. Such uneven or improper treatment may be manifest, for instance, as contrasting shades or tints between adjacent surface areas, wherein shading/tinting/coloring similar to the original fiber product may indicate that the fiber product may have received no or limited penetration or impregnation of the treatment chemical, even though the entire fiber product was exposed to the treatment chemical during the pressure treatment process.

Thus, there exists a need for a process and associated apparatus for more evenly and consistently treating a fiber-based product with a fire/heat retardant. In some instances, it may be desirable to form fire retardant-treated fiber product having an enhanced level of fire/heat resistance, wherein such a treatment for the fiber product extends below the exposed external surface of the fiber product and provides continuing fire/heat resistance if the surface treatment is breached. It may also be desirable, in some instances, to have a fiber-based product treatment process with the capability of capturing excess fire retarding solution and recycling the captured excess in subsequent product treatment cycles, whether the excess is captured in a liquid form or in other forms, such as vapors.

### SUMMARY OF THE DISCLOSURE

The above and other needs are met by aspects of the present disclosure, wherein one such aspect relates to a method of forming a fire retardant-treated fiber product. Such a method comprises directing a fiber product having opposed surfaces through a first nip defined by a pair of juxtaposed processing members each having a processing surface, wherein at least one of the processing members comprises an incisor member extending from the processing surface and configured to interact with and alter one of the opposed surfaces of the fiber product directed through the first nip. The fiber product is then directed through a second nip defined by a pair of juxtaposed compression members each having a compression surface, wherein the compression surfaces of the compression members are configured to cooperate to compress the surface of the fiber product within an elastic range associated therewith. A fire retarding solution is engaged with at least one of the first nip and the second nip such that the fiber product is interacted with the fire retarding solution at least upon entering the at least one of the first nip and the second nip.

Another aspect of the present disclosure provides an apparatus for forming a fire retardant-treated fiber product, wherein such an apparatus comprises a first nip defined by a pair of juxtaposed processing members each having a processing surface. The first nip is configured to receive a fiber product therethrough, with at least one of the processing members comprising an incisor member extending from the processing surface and configured to interact with and alter a surface of the fiber product directed through the first nip. A second nip is defined by a pair of juxtaposed compression members each having a compression surface, wherein the second nip is configured to receive the fiber product therethrough. The compression surfaces of the compression members are configured to cooperate to compress the surface of the fiber product within an elastic range associated therewith, with at least one of the first nip and the second nip being arranged to receive a fire retarding solution such that the fiber product is interacted with the fire retarding solution at least upon entering the at least one of the first nip and the second nip.

Another aspect of the present disclosure provides a method of directing a fiber product through a first nip defined by a pair of juxtaposed processing members each having a processing surface, wherein at least one of the processing members comprises an incisor member extending from the processing surface and configured to interact with and alter a surface of the fiber product directed through the first nip. The fiber product is then through a second nip defined by a pair of juxtaposed compression members each having a compression surface, wherein the compression surfaces of the compression members are configured to cooperate to compress the surface of the fiber product within an elastic range associated therewith. The second nip is also disposed in a fire retarding solution such that the fiber product is submerged in the fire retarding solution at least upon exiting the second nip.

Another aspect of the present disclosure provides an apparatus for forming a fire retardant-treated fiber product. Such an apparatus may comprise a first nip defined by a pair of juxtaposed processing members each having a processing surface, wherein the first nip is configured to receive a fiber product therethrough, and wherein at least one of the processing members comprises an incisor member extending from the processing surface and configured to interact with and alter a surface of the fiber product directed through the first nip. A second nip is defined by a pair of juxtaposed compression members each having a compression surface, wherein the second nip is configured to receive the fiber product therethrough, wherein the compression surfaces of the compression members are configured to cooperate to compress the surface of the fiber product within an elastic range associated therewith, and wherein the second nip is disposed in a fire retarding solution such that the fiber product is submerged in the fire retarding solution at least upon exiting the second nip.

Such aspects of the present disclosure, for example, minimize or eliminate the need to “pressure treat” a fiber product, such as lumber, using an ambient pressure technique to impregnate the fiber product with the desired chemical(s). In furtherance thereof, method and apparatus aspects of the present disclosure create a “localized pressure” treatment protocol using physical force acting directly on the fiber product, instead of ambient pressure, in order to impregnate the surface of fiber product (i.e., lumber) with an appropriate or desired chemical treatment. In order to effectively implement this “localized pressure” physical force technique, particular processes are required.

In one instance, for example, where the fiber product comprises lumber/timber, a significant portion of the lumber to be treated will be obtained from lumber mills, where that lumber may often be “framing lumber” (i.e., lumber which, by North American code standards, must not have higher than 19% moisture at the time of use thereof for construction). Normally, “green” or freshly-cut lumber may have a moisture content in excess of about 40% moisture. Accordingly, such lumber may usually be kiln-dried to a moisture content at or below 19% prior to use thereof in the construction industry. In doing so, the drying process may also harden the lumber, creating a surface thereof that is relatively resistant to compression. Since aspects of the present disclosure involve the application of a physical force to the fiber product, which includes a compression component, one further aspect of the present disclosure is directed to rendering the fiber product less hard/more pliable such that the fiber product is more receptive to the treatment apparatuses and methods disclosed herein. In one instance, for example, a container or “dip tank” may be provided, wherein the lumber (fiber product) may be submersed in the container to soak for a period of time (i.e., about 5 minutes to about 60 minutes, though any length of time can be specified, if necessary or desired, to soften at least the surface layer of the fiber product to the extent required to provide the desired condition of the fiber product for treatment according to the apparatuses and methods of the present disclosure). In some aspects, the “dipping” process for the fiber product requires that the lumber be submerged in an aqueous fire retarding solution for a sufficient time period so as to soften the cells and cell structures about the surface layer of the lumber, as well as allow the fire retarding solution to at least partially penetrate or absorb into the surface layer of the lumber, to render the surface layer of the lumber sufficiently pliable to be compressed/decompressed.

In another aspect of the present disclosure, the fiber product treatment apparatuses and methods involve directing the fiber product into a first nip defined by juxtaposed processing members which may, in some instances, comprise roller elements each having a processing surface. In some aspects, at least one of the processing elements may include one or more incisor members extending from the processing surface and configured to interact with and alter a surface of the fiber product, wherein, in some instances, at least one of the processing elements may also be configured to compress the fiber product via the processing surface thereof. In some aspects, the fiber product treatment apparatuses and methods may involve additional subsequent nips, with each nip comprising an additional (serially arranged) section. As such, one aspect of the present disclosure is to incise and/or compress the fiber product (i.e., lumber) through one or more sections of the fiber product treatment apparatus.

The fiber product may be treated in different manners while being processed according to the disclosed fiber product treatment apparatuses and methods. For example, the fiber product being treated could be arranged to be completely submerged in the treatment chemical (i.e., a fire retarding solution) during processing through one or more of the nips/sections. In another aspect, any of the one or more nips/section, when viewed in cross-section, can be divided into quadrants, namely a first (i.e., upper) and a second (i.e., lower) quadrant upon the fiber product entering the nip and engaging the roller elements, and a first (i.e., upper) and a second (i.e., lower) quadrant upon the fiber product exiting the nip and disengaging the roller elements. In such aspects, the treatment chemical (i.e., a fire retarding solution) may be directed to or otherwise provided at the nip to form a “flooded nip” at either or both quadrants of the nip entrance and/or at either or both quadrants of the nip exit. In one instance, the entrance to the first nip formed by juxtaposed processing members may both the top and bottom quadrants flooded with the fire retarding solution during processing of the fiber product.

During processing of the fiber product through the first nip, configured as disclosed herein, flooding the entrance and/or exit of the first nip with the fire retarding solution may allow for some absorption of the fire retarding solution by the surface layer of the fiber product. Because the first nip is flooded, upon the incisor(s) of at least one of the processing members being physically forced or urged into engagement with the surface layer of the fiber product (lumber), the penetrating incisor(s) (incisor member) may at least partially force or urge the fire retarding solution into the incised cavity formed by each incisor member. In some instances, the depth of penetration of each incisor member into the surface layer of the fiber product may be regulated according to the size (i.e., length or depth) of the particular incisor member. In some instances, the surface of the processing member from which the incisor(s) protrude may comprise a smooth cylindrical surface (i.e., a smooth processing surface in the manner of a cylindrical roller element). As such, in some aspects, a processing member/roller element configured in this manner may also function as a compression member via the smooth processing surface, as well as an incising arrangement via the one or more incising members. With such an incision/compression member (i.e., “compression incisor”), as the one or more incisor elements penetrate the surface layer of the fiber product entering the flooded first nip, the smooth cylindrical surface also compresses the surface layer of the fiber product to force or urge the fire retarding solution into the surface layer.

That is, compressing the surface layer of the fiber product, within an elastic or nondestructive force limit, compresses air out of the cell structures about the surface layer (i.e., of the lumber having the surface layer rendered pliable by “pre-soaking”). Since the first nip is flooded, the smooth cylindrical processing surface of the processing member may also function to force or urge the fire retarding solution into the surface layer of the fiber product, while air trapped or retained in the surface layer is expelled. This compression of the surface layer may remove a portion of the fire retarding solution penetrating the surface layer. However, as the fiber product passes through and exits the first nip by disengaging the processing elements, the decompression of the fiber product may cause the fiber product to re-absorb additional amounts of the fire retarding solution (i.e., in a sponge-type effect). In some instances, as the fiber product exits the first nip, one or both quadrants about the nip exit may also be flooded so as to supply the de-compressing fiber product exiting the first nip with additional amounts of the fire retarding solution for facilitating the absorption thereof by the fiber product due to the sponge-type effect (i.e., decompression causing a localized surface suction/absorption).

In some aspects, following the first nip, a similar process may be repeated in regard to a second nip formed by juxtaposed smooth compression members (i.e., compression rollers) each having a compression surface, wherein the second nip entrance and/or second nip exit quadrants are flooded with the fire retarding solution and the fiber product is compressed by the compression surfaces of the compression members upon entering the second nip and then allowed to de-compress upon exiting the second nip. The compression surfaces of the smooth compression members/rollers in the second nip implement the applied compression to further force or urge the fire retarding solution into the cavities or incisions created in the fiber product in the first nip. In some aspects, the fiber product may be directed through one or more subsequent nips, as necessary or desired, to further facilitate penetration of the fire retarding solution into the fiber product. However, if the treatment process is completed at this point, the fiber product may be directed to an appropriate arrangement for drying.

The fiber product treatment apparatuses and methods disclosed herein as representing various aspects of the present disclosure, may exhibit, for example, a significant tolerance of variability in the feed rate of the fiber product therethrough that is required to provide and maintain effective application of the chemical treatment to the fiber product units, as well as consistency in the treatment across the units of the fiber product. For example, the penetration of the chemical treatment into the fiber product may be similar at a feed rate of the fiber products of 20 feet per minute as at a feed rate of 200 feet per minute. As such, unit volume output by the fiber product treatment apparatuses and methods disclosed herein may be increased, for instance, by a factor of 10 or more compared to a pressure treatment using single charge pressure vessels, thereby resulting, for example, in lower production costs and greater profitability. The present disclosure thus includes, without limitation, the following embodiments:

### Embodiment 1

A method of forming a fire retardant-treated fiber product, comprising directing a fiber product having opposed surfaces through a first nip defined by a pair of juxtaposed processing members each having a processing surface, with at least one of the processing members comprising an incisor member extending from the processing surface and configured to interact with and alter one of the opposed surfaces of the fiber product directed through the first nip; directing the fiber product through a second nip defined by a pair of juxtaposed compression members each having a compression surface, with the compression surfaces of the compression members being configured to cooperate to compress the surface of the fiber product within an elastic range associated therewith; and engaging a fire retarding solution with at least one of the first nip and the second nip such that the fiber product is interacted with the fire retarding solution at least upon entering the at least one of the first nip and the second nip.

### Embodiment 2

The method of any preceding or subsequent embodiment, or combinations thereof, wherein engaging a fire retarding solution with at least one of the first nip and the second nip further comprises submerging the at least one of the first nip and the second nip in the fire-retarding solution.

### Embodiment 3

The method of any preceding or subsequent embodiment, or combinations thereof, wherein engaging a fire retarding solution with at least one of the first nip and the second nip further comprises one of directing the fire retarding solution toward an entrance of the at least one of the first nip and the second nip such that the fire retarding solution interacts with at least one of the opposed surfaces of the fiber product upon engagement thereof with the corresponding one of the processing members or the compression members, and directing the fire retarding solution toward an exit of the at least one of the first nip and the second nip such that the fire retarding solution interacts with at least one of the opposed surfaces of the fiber product upon disengagement thereof from the corresponding one of the processing members and the compression members.

### Embodiment 4

The method of any preceding or subsequent embodiment, or combinations thereof, further comprising submerging the fiber product in the fire retarding solution prior to directing the fiber product through the first nip, and optionally maintaining the fiber product submerged in the fire retarding solution for a selected time period prior to directing the fiber product through the first nip.

### Embodiment 5

The method of any preceding or subsequent embodiment, or combinations thereof, wherein directing the fiber product through the first nip further comprises directing the fiber product through the first nip, wherein the processing surfaces of the processing members of the first nip are further configured to cooperate to compress the surface of the fiber product within an elastic range associated therewith.

### Embodiment 6

The method of any preceding or subsequent embodiment, or combinations thereof, wherein the first nip is disposed in the fire retarding solution, and directing a fiber product further comprises directing a fiber product through the first nip such that the fiber product is submerged in the fire retarding solution at least upon exiting the first nip.

### Embodiment 7

The method of any preceding or subsequent embodiment, or combinations thereof, wherein the first and second nips are disposed in the fire retarding solution, and directing the fiber product through the first and second nips further comprises directing the fiber product through the first and second nips such that the fiber product is continually submerged in the fire retarding solution from prior to the first nip through subsequent to the second nip.

### Embodiment 8

The method of any preceding or subsequent embodiment, or combinations thereof, wherein submerging the fiber product in the fire retarding solution comprises submerging the fiber product in the fire retarding solution in a first container and directing the fiber product through the first nip comprises directing the fiber product through the first nip in a second container, and the method further comprises directing the fiber product from the first container to the second container while maintaining the fiber product submerged in the fire retarding solution, and optionally sealing the first and second containers upon receiving the fiber product in the first container so as to minimize evaporation of the fire retarding solution.

### Embodiment 9

The method of any preceding or subsequent embodiment, or combinations thereof, further comprising directing the fiber product through a third nip defined by a pair of juxtaposed processing members each having a processing surface, the third nip being oriented perpendicularly to the first nip and being disposed prior to the second nip, wherein at least one of the processing members comprises an incisor member extending from the processing surface thereof and configured to interact with and alter a corresponding surface of the fiber product directed through the third nip.

### Embodiment 10

The method of any preceding or subsequent embodiment, or combinations thereof, wherein directing the fiber product through the third nip further comprises directing the fiber product through the third nip, wherein the processing surfaces of the processing members of the third nip are further configured to cooperate to compress the surface of the fiber product within an elastic range associated therewith.

### Embodiment 11

The method of any preceding or subsequent embodiment, or combinations thereof, further comprising one of directing the fire retarding solution toward an entrance of the third nip such that the fire retarding solution interacts with at least one of the corresponding surfaces of the fiber product upon engagement thereof with the processing members, and directing the fire retarding solution toward an exit of the third nip such that the fire retarding solution interacts with at least one of the corresponding surfaces of the fiber product upon disengagement thereof from the processing members.

### Embodiment 12

The method of any preceding or subsequent embodiment, or combinations thereof, further comprising directing the fiber product through a fourth nip defined by a pair of juxtaposed compression members each having a compression surface, the fourth nip being oriented perpendicularly to the second nip and being disposed subsequent to the first nip, wherein the compression surfaces of the compression members are configured to cooperate to compress the surface of the fiber product within an elastic range associated therewith.

### Embodiment 13

The method of any preceding or subsequent embodiment, or combinations thereof, further comprising one of directing the fire retarding solution toward an entrance of the fourth nip such that the fire retarding solution interacts with at least one of the corresponding surfaces of the fiber product upon engagement thereof with the processing members, and directing the fire retarding solution toward an exit of the fourth nip such that the fire retarding solution interacts with at least one of the corresponding surfaces of the fiber product upon disengagement thereof from the compression members.

### Embodiment 14

The method of any preceding or subsequent embodiment, or combinations thereof, wherein each processing member comprises a plurality of incisor members extending from the processing surface and arranged across a width thereof, and directing a fiber product through a first nip further comprises directing the fiber product through the first nip to interact the plurality of incisor members with the fiber product across a width thereof and to alter the surface of the fiber product across the width and along a length thereof.

### Embodiment 15

The method of any preceding or subsequent embodiment, or combinations thereof, wherein directing a fiber product through a first nip for at least one incisor member extending from the processing surface to interact with and alter a surface of the fiber product further comprises directing the fiber product through the first nip for the at least one incisor member extending from the processing surface to interact with and penetrate the surface of the fiber product.

### Embodiment 16

The method of any preceding or subsequent embodiment, or combinations thereof, further comprising directing the fiber product from the second nip through a fifth nip defined by a pair of juxtaposed processing members each having a processing surface, at least one of the processing members comprising an incisor member extending from the processing surface thereof and configured to interact with and alter a surface of the fiber product directed through the fifth nip, and optionally directing the fiber product from the fifth nip through a sixth nip defined by a pair of juxtaposed compression members each having a compression surface, the compression surfaces of the compression members being configured to cooperate to compress the surface of the fiber product within the elastic range associated therewith.

### Embodiment 17

The method according to claim 1, wherein engaging a fire retarding solution with at least one of the first nip and the second nip further comprises engaging a fire retarding solution with at least one of the first nip and the second nip, wherein the fire retarding solution comprises one of a boron compound, a phosphorus compound, a chlorine compound, a fluorine compound, an antimony compound, a borate compound, a halogen compound, boric acid, an inorganic hydrate, a bromine compound, aluminum hydroxide, magnesium hydroxide, hydromagnesite, antimony trioxide, a phosphonium salt, ammonium phosphate, diammonium phosphate, methyl bromide, methyl iodide, bromochlorodifluoromethane, dibromotetrafluoroethane, dibromodifluoromethane, carbon tetrachloride, urea-potassium bicarbonate, and combinations thereof.

### Embodiment 18

The method of any preceding or subsequent embodiment, or combinations thereof, further comprising de-liquefying the fiber product subsequent to the second nip.

### Embodiment 19

The method of any preceding or subsequent embodiment, or combinations thereof, wherein engaging a fire retarding solution with at least one of the first nip and the second nip further comprises engaging a fire retarding solution with at least one of the first nip and the second nip, wherein the fire retarding solution comprises one of an aqueous fire retarding solution, a nontoxic liquid fire retarding solution, and a neutral pH liquid fire retarding solution.

### Embodiment 20

An apparatus for forming a fire retardant-treated fiber product, comprising a first nip defined by a pair of juxtaposed processing members each having a processing surface, the first nip being configured to receive a fiber product therethrough, with at least one of the processing members comprising an incisor member extending from the processing surface thereof and configured to interact with and alter a surface of the fiber product directed through the first nip; and a second nip defined by a pair of juxtaposed compression members each having a compression surface, the second nip being configured to receive the fiber product therethrough, with the compression surfaces of the compression members being configured to cooperate to compress the surface of the fiber product within an elastic range associated therewith, and with at least one of the first nip and the second nip being arranged to receive a fire retarding solution such that the fiber product is interacted with the fire retarding solution at least upon entering the at least one of the first nip and the second nip.

### Embodiment 21

The apparatus of any preceding or subsequent embodiment, or combinations thereof, wherein the at least one of the first nip and the second nip is arranged to be submerged in the fire-retarding solution.

### Embodiment 22

The apparatus of any preceding or subsequent embodiment, or combinations thereof, wherein the at least one of the first nip and the second nip is arranged to one of receive the fire retarding solution about an entrance thereof such that the fire retarding solution interacts with at least one of the opposed surfaces of the fiber product upon engagement thereof with the corresponding one of the processing members or the compression members, and receive the fire retarding solution about an exit thereof such that the fire retarding solution interacts with at least one of the opposed surfaces of the fiber product upon disengagement thereof from the corresponding one of the processing members and the compression members.

### Embodiment 23

The apparatus of any preceding or subsequent embodiment, or combinations thereof, wherein the processing surfaces of the processing members of the first nip are further configured to cooperate to compress the surface of the fiber product within an elastic range associated therewith.

### Embodiment 24

The apparatus of any preceding or subsequent embodiment, or combinations thereof, wherein the first nip is disposed in the fire retarding solution such that the fiber product is submerged in the fire retarding solution at least upon exiting the first nip.

### Embodiment 25

The apparatus of any preceding or subsequent embodiment, or combinations thereof, wherein the first and second nips are disposed in the fire retarding solution such that the fiber product is continually submerged in the fire retarding solution from prior to the first nip through subsequent to the second nip.

### Embodiment 26

The apparatus of any preceding or subsequent embodiment, or combinations thereof, further comprising a first container configured to receive the fiber product such that the fiber product is submerged in the fire retarding solution prior to being received through the first nip, and optionally further comprising a second container configured to receive the first nip and the second nip therein, the second container being in fluid communication with the first container to allow the fiber product to be directed from the first container to the second container while maintaining the fiber product submerged in the fire retarding solution, and optionally wherein the first and second containers are configured to be sealable upon the fiber product being received in the first container so as to minimize evaporation of the fire retarding solution.

### Embodiment 27

The apparatus of any preceding or subsequent embodiment, or combinations thereof, further comprising a third nip defined by a pair of juxtaposed processing members each having a processing surface, and configured to receive the fiber product therethrough, the third nip being oriented perpendicularly to the first nip and being disposed prior to the second nip, wherein at least one of the processing members comprises an incisor member extending from the processing surface thereof and configured to interact with and alter a corresponding surface of the fiber product directed through the third nip, and optionally wherein the processing surfaces of the processing members of the third nip are further configured to cooperate to compress the surface of the fiber product within an elastic range associated therewith.

### Embodiment 28

The apparatus of any preceding or subsequent embodiment, or combinations thereof, wherein the third nip is arranged to one of receive the fire retarding solution about an entrance thereof such that the fire retarding solution interacts with at least one of the corresponding surfaces of the fiber product upon engagement thereof with the processing members, and receive the fire retarding solution about an exit thereof such that the fire retarding solution interacts with at least one of the corresponding surfaces of the fiber product upon disengagement thereof from the processing members.

### Embodiment 29

The apparatus of any preceding or subsequent embodiment, or combinations thereof, further comprising a fourth nip defined by a pair of juxtaposed compression members each having a compression surface, and configured to receive the fiber product therethrough, the fourth nip being oriented perpendicularly to the second nip and being disposed subsequent to the first nip, wherein the compression surfaces of the compression members are configured to cooperate to compress the surface of the fiber product within an elastic range associated therewith.

### Embodiment 30

The apparatus of any preceding or subsequent embodiment, or combinations thereof, wherein the fourth nip is arranged to one of receive the fire retarding solution about an entrance thereof such that the fire retarding solution interacts with at least one of the corresponding surfaces of the fiber product upon engagement thereof with the processing members, and receive the fire retarding solution about an exit thereof such that the fire retarding solution interacts with at least one of the corresponding surfaces of the fiber product upon disengagement thereof from the compression members.

### Embodiment 31

The apparatus of any preceding or subsequent embodiment, or combinations thereof, wherein each processing member comprises a plurality of incisor members extending from the processing surface and arranged across a width thereof, the plurality of incisor members being configured to interact with the fiber product across a width thereof and to alter the surface of the fiber product across the width and along a length thereof.

### Embodiment 32

The apparatus of any preceding or subsequent embodiment, or combinations thereof, the at least one incisor member of the first nip is configured to interact with and penetrate the surface of the fiber product.

### Embodiment 33

The apparatus of any preceding or subsequent embodiment, or combinations thereof, further comprising a fifth nip defined by a pair of juxtaposed processing members each having a processing surface, and configured to receive the fiber product therethrough from the second nip, at least one of the processing members comprising an incisor member extending from the processing surface thereof and configured to interact with and alter a surface of the fiber product directed through the fifth nip, and optionally further comprising a sixth nip defined by a pair of juxtaposed compression members each having a compression surface, and configured to receive the fiber product therethrough from the fifth nip, the compression surfaces of the compression members being configured to cooperate to compress the surface of the fiber product within the elastic range associated therewith.

### Embodiment 34

The apparatus of any preceding or subsequent embodiment, or combinations thereof, wherein the fire retarding solution comprises one of a boron compound, a phosphorus compound, a chlorine compound, a fluorine compound, an antimony compound, a borate compound, a halogen compound, boric acid, an inorganic hydrate, a bromine compound, aluminum hydroxide, magnesium hydroxide, hydromagnesite, antimony trioxide, a phosphonium salt, ammonium phosphate, diammonium phosphate, methyl bromide, methyl iodide, bromochlorodifluoromethane, dibromotetrafluoroethane, dibromodifluoromethane, carbon tetrachloride, urea-potassium bicarbonate, and combinations thereof.

### Embodiment 35

The apparatus of any preceding or subsequent embodiment, or combinations thereof, further comprising a de-liquefying arrangement configured to receive and de-liquefy the fiber product subsequent to the second nip.

### Embodiment 36

The apparatus of any preceding or subsequent embodiment, or combinations thereof, wherein the fire retarding solution comprises one of an aqueous fire retarding solution, a nontoxic liquid fire retarding solution, and a neutral pH liquid fire retarding solution.

These and other features, aspects, and advantages of the present disclosure will be apparent from a reading of the following detailed description together with the accompanying drawings, which are briefly described below. The present disclosure includes any combination of two, three, four, or more features or elements set forth in this disclosure, regardless of whether such features or elements are expressly combined or otherwise recited in a specific embodiment description herein. This disclosure is intended to be read holistically such that any separable features or elements of the disclosure, in any of its aspects and embodiments, should be viewed as intended, namely to be combinable, unless the context of the disclosure clearly dictates otherwise.

### BRIEF DESCRIPTION OF THE SEVERAL VIEWS OF THE DRAWING(S)

Having thus described the disclosure in general terms, reference will now be made to the accompanying drawings, which are not necessarily drawn to scale, and wherein:

FIG. 1 schematically illustrates an apparatus for treating a fiber product with a fire retardant, according to one aspect of the disclosure;

FIG. 2 schematically illustrates two processing nips disposed perpendicularly to each other, as a portion of an apparatus for treating a fiber product with a fire retardant according to one aspect of the disclosure;

FIG. 3 schematically illustrates two compression nips disposed perpendicularly to each other, as a portion of an apparatus for treating a fiber product with a fire retardant according to one aspect of the disclosure;

FIG. 4 schematically illustrates an apparatus for treating a fiber product with a fire retardant, according to another aspect of the disclosure;

FIG. 5 schematically illustrates a de-liquefying and recovery arrangement, as a portion of an apparatus for treating a fiber product with a fire retardant according to one aspect of the disclosure; and

FIG. 6 schematically illustrates a method for treating a fiber product with a fire retardant, according to one aspect of the disclosure.

### DETAILED DESCRIPTION OF THE DISCLOSURE

The present disclosure now will be described more fully hereinafter with reference to the accompanying drawings, in which some, but not all aspects of the disclosure are shown. Indeed, the disclosure may be embodied in many different forms and should not be construed as limited to the aspects set forth herein; rather, these aspects are provided so that this disclosure will satisfy applicable legal requirements. Like numbers refer to like elements throughout.

Aspects of the present disclosure are generally directed to apparatuses and methods for forming a fire retardant-treated fiber product. As previously discussed, possible limitations in the treatment of as-formed fiber products, such as a lumber or other board product, for fire resistance, particularly with a liquid fire retardant, include difficulty in achieving an even and consistent treatment of that fiber product, particularly where it may be desirable for the treatment to extend below the surface of the product. Techniques for treating such products, such as a pressure treating process, may also be time consuming, as well as environmentally hazardous, among other shortcomings. Further, such a pressure treating process may not necessarily affect the fire and/or heat resistance of the as-formed product. Aspects of the present disclosure are thus directed to, for example, minimizing or eliminating the need to “pressure treat” an as-formed fiber product, such as lumber, using an ambient pressure technique to impregnate the fiber product with the desired chemical(s). In furtherance thereof, method and apparatus aspects of the present disclosure create a “localized pressure” treatment protocol using physical force acting directly on the fiber product, instead of ambient pressure, in order to impregnate the surface of fiber product (i.e., lumber) with an appropriate or desired chemical treatment. In order to effectively implement this “localized pressure” physical force technique, particular processes are required.

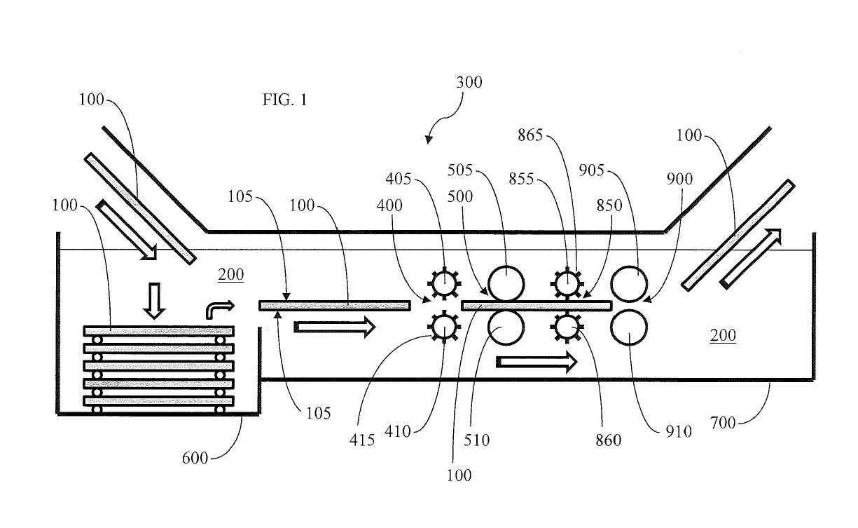

As such, one aspect of the present disclosure involves an apparatus for forming a fire resistant-treated fiber product, such an apparatus being indicated as element 100 in FIG. 1. Such a fiber product 100 may generally be cellulose-based and existing as a monolithic solid in an as-formed state. For example, a suitable fiber product may comprise, for example, hardwood lumber, softwood lumber, engineered board, plywood. Generally, the fiber product 100 may be characterized by having two pairs of opposed generally planar (and laterally-extending) surfaces, wherein the opposed pairs are disposed substantially perpendicularly to each other. However, there may be instances in which the fiber product 100 includes only one pair of opposed generally planar (and laterally-extending) surfaces, or even just one generally planar surface.

Moreover, it may be desirable, though not absolutely necessary, for the fiber product 100 to be at least minimally compressible. In being generally compressible, it may be desirable for the fiber product 100 to have at least some moisture content. For example, it may be desirable for live or freshly cut wood to have a moisture content of at least about 5%, at least about 10%, or between about 5% and about 25%. As such, it may be preferred for the fiber product 100 to comprise wood, lumber, timber, board, planks, logs, or any cellulose-based element. However, in instances wherein the fiber product 100 is constructed (i.e., engineered lumber), it may be preferred that the fiber product 100 comprise exclusively cellulose fibers, substantially exclusively cellulose fibers, primarily cellulose fibers, or at least a majority of cellulose fibers. One skilled in the art will appreciate from the disclosure herein that, in some aspects, contaminants may be present in reasonable levels in the fiber product 100 and will likely have little, if any, detrimental effect with respect to the resulting as-formed, fire retardant-treated fiber product 100. As such, a decontamination process/apparatus may not necessarily be contemplated (e.g., for the fiber product 100, prior to being formed or as-formed), but could be included, should there be a need or desire for a contaminant-free fiber product 100.

In particular aspects, a suitable fire retarding solution 200 may be used to treat the fiber product 100, wherein the fire retarding solution 200 may be an aqueous fire retarding solution. It may be preferred that the fire retarding solution be nontoxic and/or have a neutral pH and/or be hypoallergenic and/or have any number of otherwise desirable properties that do not have an adverse affect or otherwise have a minimal adverse affect on human/animal and/or environmental safety, while maintaining the necessary efficacy, as implemented and upon exposure of the fiber product 100 to heat and/or flame. In some aspects, the fire retarding solution 200 may include a component which, standing alone, may not necessarily exhibit one or more of the previously-disclosed preferred or desirable properties. However, one skilled in the art will appreciate that other different components of the fire retarding solution 200 may interact with the noted component so as to neutralize, minimize, or otherwise eliminate, chemically or otherwise, the non-preferred or undesirable properties of the noted component such that the overall fire retarding solution 200 exhibits one or more of the preferred or desirable properties. In some other aspects, the fire retarding solution 200 may comprise any one or more of a boron compound, a phosphorus compound, a chlorine compound, a fluorine compound, an antimony compound, a borate compound, a halogen compound, boric acid, an inorganic hydrate, a bromine compound, aluminum hydroxide, magnesium hydroxide, hydromagnesite, antimony trioxide, a phosphonium salt, ammonium phosphate, diammonium phosphate, methyl bromide, methyl iodide, bromochlorodifluoromethane, dibromotetrafluoroethane, dibromodifluoromethane, carbon tetrachloride, urea-potassium bicarbonate, and combinations thereof. In this regard, one skilled in the art will appreciate that various fire retarding or fire resistant substances, either currently known or later developed or discovered, may be applicable to the disclosed processes and apparatuses herein within the scope of the present disclosure. One skilled in the art will further appreciate that the fire retarding solution 200 may be formed by adding a solid fire retardant product to a liquid (i.e., water) or other chemical such that the solid fire-retardant product forms a solution with the liquid or other chemical.

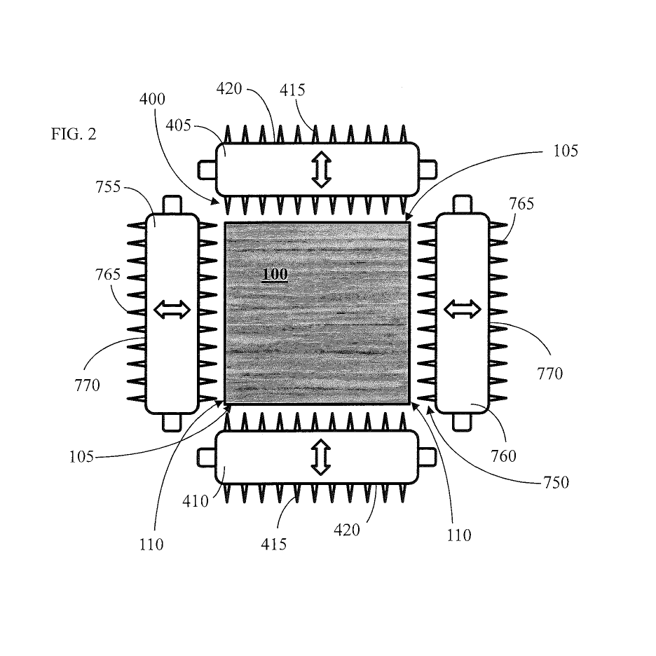

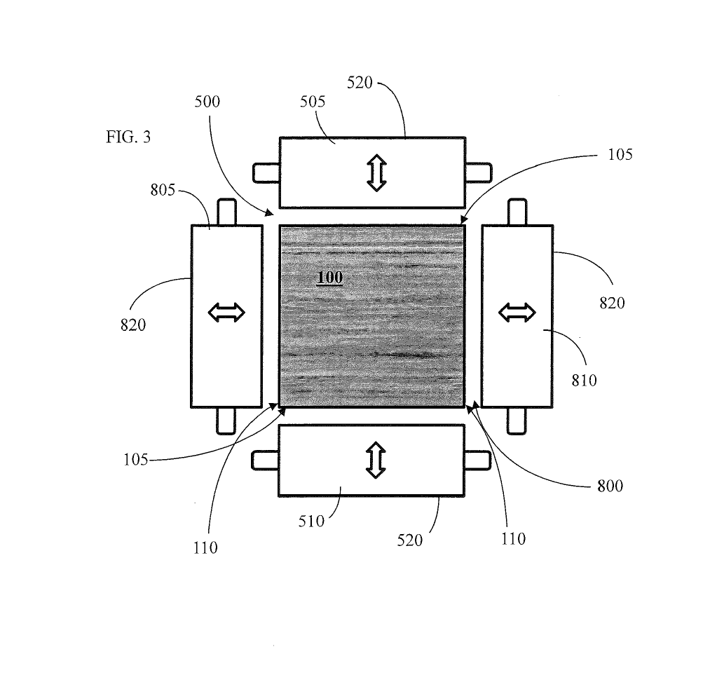

Particular aspects of the present disclosure may comprise an apparatus 300 (see, e.g., FIG. 1) for forming a fire retardant-treated fiber product 100. Such an apparatus 300 may comprise, for instance, a first nip 400 defined by a pair of juxtaposed processing members 405, 410, each having a processing surface 420 (see, e.g., FIG. 2). The first nip 400 is particularly configured to receive the fiber product 100 therethrough. In this regard, at least one of the processing members 405, 410 may comprise an incisor member 415 extending from the processing surface 420 thereof and configured to interact with and alter a surface 105 of the fiber product 100 directed through the first nip 400. A second nip 500 may be defined by a pair of juxtaposed compression members 505, 510 each having a compression surface 520 (see, e.g., FIG. 3). The second nip 500 is also configured to receive the fiber product 100 therethrough, in some instances, directly from the first nip 400. The compression surfaces 520 of the compression members 505, 510 may be configured to cooperate to compress the surface 105 of the fiber product 100 within an elastic range (or otherwise in a nondestructive range) associated therewith. In some instances, at least the second nip 500 may be disposed in the fire retarding solution 200, such that the fiber product 100 is submerged in the fire retarding solution 200 at least upon exiting the second nip 500.

In one aspect, the first nip 400 is configured to support the at least one incisor member 415 such that the at least one incisor member 415 is urged into interaction with the fiber product 100 received through the nip 400. In some instances, the juxtaposed processing members 405, 410 may comprise rotatable rolls arranged such that the axes thereof are disposed substantially in parallel, as will be appreciated by one skilled in the art. One or both of the rolls may include at least one incisor member 415 mounted thereto or otherwise operably engaged therewith, so as to extend outwardly of an outer or processing surface 420 of the respective roll. In some instances, one or both of the rolls may include a plurality of incisor members 415 extending from the processing surface 420 thereof and arranged in a spaced apart manner across the width of the roll, and/or around the circumference thereof. The processing surfaces 420 of the rolls may further be configured to be substantially smooth (i.e., forming substantially smooth cylindrical rolls) and having the incisor members 415 extending from the smooth cylindrical surface (i.e., the processing surface 420) thereof. In some instances, a plurality of incisor members 415 may be provided in a plurality of columns across the width of the roll and extending from the substantially smooth processing surface 420 thereof, wherein every other column is shifted around the circumference, and wherein the overall effect is a plurality of staggered rows of incisor members 415 around the circumference of the roll and extending from the substantially smooth processing surface 420 thereof.

The at least one incisor member 415 extending outwardly of the outer or processing surface 420 of the roll representing one of the processing members 405, 410, when brought into engagement with the fiber product 100, is thus configured to interact with and alter the engaged surface 105 of the fiber product 100. In some instances, the at least one incisor member 415 is configured to interact with and penetrate the surface 105 of the fiber product 100. That is, the at least one incisor member 415 may be configured to indent, slit, chop, punch, pierce, or otherwise penetrate the surface 105 of the fiber product 100. For example, the at least one incisor member 415 may comprise a blade, a spike, or a nub. In some instances, it may be preferable to expose at least some of the fibers disposed below the outer surface 105 of the fiber product 100, as further disclosed herein. Because the at least one incisor member 415 is engaged with processing surface 420 of the rotatable roll(s) comprising the processing members 405, 410, introduction of the fiber product 100 into the first nip 400 generally indicates that the fiber product 100 is directed completely through the first nip 400 such that the incisor member(s) 415 interact with the fiber product 100 substantially across a width thereof, as well as substantially along a length thereof.

The processing members 405, 410 may be mounted and arranged to also provide a desired compression therebetween via the substantially smooth cylindrical processing surfaces 420 from which the at least one incisor member 415 extends, but without crushing the fiber product 100 directed therethrough. In some instances, the processing members 405, 410 may have the incisor members 415 thereof separated by a distance substantially equal to a thickness of the fiber product 100, which may allow only the at least one incisor member 415 protruding from the processing surface 420 of the processing member(s) to interact with, compress, and/or alter (or penetrate) the surface of the fiber product 100, but without crushing the fiber product 100 or surface thereof. In other instances, the processing members 405, 410 may have the substantially smooth cylindrical processing surfaces 420 thereof separated by a distance substantially equal to a thickness of the fiber product 100, which may allow the at least one incisor member 415 protruding from the processing surface 420 of the processing member(s) to interact with and alter (or penetrate) the surface of the fiber product 100, as well as the smooth processing surfaces 420 of the processing member 405, 410 to interact with and compress the surface of the fiber product 100 within an elastic range (or otherwise a nondestructive range) associated therewith, but in either instance without crushing the fiber product 100 or surface thereof. The processing members 405, 410 may further be mounted so as to be rotatable. One skilled in the art will also appreciate that at least one of the processing members 405, 410 may be mounted to be movable with respect to the other such that the distance therebetween (i.e., the compression imparted to the fiber product 100) may be adjusted. For example, the at least one of the processing members 405, 410 may be mounted on a movable arm (not shown) and engaged with a suitable actuator (i.e. a hydraulic actuator) in order to be movable with respect to the other processing member. One skilled in the art will appreciate that the movement of the at least one of the processing members 405, 410 may be accomplished manually or automatically (i.e., through the use of appropriate sensors and computer logic).

In being processed through the first nip 400, penetration of the fire retarding solution into the fiber product 100 through the surface 105 thereof may be enhanced, in some instances, by the surface 105 of the fiber product 100 being altered or penetrated by the at least one incisor member 415 during processing of the fiber product 100 through the first nip 400. That is, the penetration of the surface 105 by the at least one incisor member 415 may facilitate the intake of the fire retarding solution into the fiber product 100 since the integrity of the surface 105 has been disrupted by processing the fiber product 100 through the first nip 400. The penetration of the surface 105 may thus disrupt the surface tension imparted by the integrity of the unpenetrated surface 105, which may otherwise be an impediment to surface penetration by the fire retarding solution 200, thereby enhancing intake and penetration of the fire retarding solution 200 into the fiber product 100 below the surface 105. The surface 105 of the fiber product 100 may also be elastically compressed in the first nip 400 by the processing surfaces 420, and may further re-expand or decompress back to the original uncompressed dimension following the first nip 400. As such, the re-expansion or decompression may additionally cause a vacuum, suction, or other low pressure condition to exist at or about the surface 105 of the fiber product 100 following the first nip 400 such that the surface 105, submerged in the fire retarding solution 200, draws the fire retarding solution 200 into the fiber product 100 through the surface 105 thereof (i.e., a “sponge” effect), in addition to penetration of the fire-retarding solution through the surface alteration(s) formed by the at least one incisor member 415.

Once the fiber product 100 is processed through the first nip 400, the fiber product 100 having the incised, penetrated, or otherwise altered surface 105, may then be serially directed to the second nip 500. The pair of juxtaposed compression members 505, 510, each having a compression surface 520, and defining the second nip 500, may be configured to receive the fiber product 100 therethrough, in some instances, directly from the first nip 400. As disclosed, the compression surfaces 520 of the compression members 505, 510 may be configured to cooperate to compress the surface 105 of the fiber product 100 within an elastic range (or otherwise a nondestructive range) associated therewith. In some instances, the compression members 505, 510 may comprise rotatable smooth cylindrical rolls (i.e., the compression surfaces 520 are substantially smooth and cylindrical). As with the processing members 405, 410 in the first nip 400, the compression members 505, 510 may likewise be mounted such that at least one of the compression members is movable with respect to the other to adjust the distance therebetween and thus the compression imparted by the second nip 500. In this instance, it may be preferable for the compression members 505, 510 to be spaced apart or otherwise arranged for the substantially smooth compression surfaces 520 to cooperate to compress the fiber product 100 within an elastic limit (or otherwise within a nondestructive range) such that the surface 105 of the fiber product 100 essentially springs back or decompresses after the second nip 500 and such that the thickness of the fiber product 100 does not appreciably or materially change following the second nip 500. The compression members 505, 510 may further be mounted so as to be rotatable. One skilled in the art will also appreciate that at least one of the compression members 505, 510 may be mounted to be movable with respect to the other such that the distance therebetween (i.e., the distance between the compression surfaces 520 and thus the compression imparted to the fiber product 100) may be adjusted. For example, the at least one of the compression members 505, 510 may be mounted on a movable arm (not shown) and engaged with a suitable actuator (i.e. a hydraulic actuator) in order to be movable with respect to the other processing member. One skilled in the art will appreciate that the movement of the at least one of the compression members 505, 510 may be accomplished manually or automatically (i.e., through the use of appropriate sensors and computer logic).

In one particular aspect, the second nip 500 may be disposed in the fire retarding solution 200 such that the fiber product 100 is submerged in the fire retarding solution 200, at least upon exiting the second nip 500. In this regard, the surface 105 of the fiber product 100 elastically compressed in the second nip 500 may re-expand or decompress back to the original uncompressed dimension following the second nip 500. As such, the re-expansion or decompression may cause a vacuum, suction, or other low pressure condition to exist at or about the surface 105 of the fiber product 100 following the second nip 500 such that the surface 105, submerged in the fire retarding solution 200, draws the fire retarding solution 200 into the fiber product 100 through the surface 105 thereof (i.e., a “sponge” effect). In this regard, the penetration of the fire retarding solution into the fiber product 100 through the surface 105 thereof may be enhanced, in some instances, by the surface 105 of the fiber product 100 being altered or penetrated by processing thereof through the first nip 400. That is, the penetration of the surface 105 by the at least one incisor member 415 may facilitate the intake of the fire retarding solution into the fiber product 100 since the integrity of the surface 105 has been disrupted by processing the fiber product 100 through the first nip 400, thus disrupting the surface tension imparted by the integrity of the surface 105, which may otherwise be an impediment to surface penetration by the fire retarding solution 200, and thereby enhancing intake and penetration of the fire retarding solution 200 into the fiber product 100 below the surface 105.

According to this aspect, it may be preferable for the second nip 500 to be submerged in the fire retarding solution 200 such that the fiber product 100 is exposed to the fire retarding solution 200 prior to, during, and after the second nip 500. In some instances, the first nip 400 may also be disposed in the fire retarding solution 200 such that the fiber product 100 is submerged in the fire retarding solution 200 at least upon exiting the first nip 400. In yet other instances, it may be preferable for the first nip 400 to be submerged in the fire retarding solution 200 such that the fiber product 100 is exposed to the fire retarding solution 200 prior to, during, and after the first nip 400. Also, in some aspects, both the first and second nips 400, 500 may be disposed in the fire retarding solution 200 such that the fiber product 100 is continually submerged in the fire retarding solution 200 from prior to the first nip 400 through subsequent to the second nip 500.

In some instances, for example, where the fiber product may comprise lumber/timber, a significant portion of the lumber to be treated will be obtained from lumber mills, where that lumber may often be “framing lumber” (i.e., lumber which, by North American code standards, must not have higher than 19% moisture at the time of use thereof for construction). Normally, “green” or freshly-cut lumber may have a moisture content in excess of about 40% moisture. Accordingly, such lumber may usually be kiln-dried to a moisture content at or below 19% prior to use thereof in the construction industry. In doing so, the drying process may also harden the lumber, creating a surface thereof that is relatively resistant to compression. Since aspects of the present disclosure involve the application of a physical force to the fiber product, which includes a compression component, one further aspect of the present disclosure is directed to rendering the fiber product less hard/more pliable such that the fiber product is more receptive to the treatment apparatuses and methods disclosed herein.

In one instance, for example, a container or “dip tank” (see, e.g., element 600 in FIG. 1) may be provided, wherein the lumber (fiber product) may be submersed in the container to soak for a period of time (i.e., about 5 minutes to about 60 minutes, though any length of time can be specified, if necessary or desired, to soften at least the surface layer of the fiber product to the extent required to provide the desired condition of the fiber product for treatment according to the apparatuses and methods of the present disclosure). In some aspects, the “dipping” process for the fiber product requires that the lumber be submerged in an aqueous fire retarding solution for a sufficient time period so as to soften the cells and cell structures about the surface layer of the lumber, as well as allow the fire retarding solution to at least partially penetrate or absorb into the surface layer of the lumber, to render the surface layer of the lumber sufficiently pliable to be compressed/decompressed.

Accordingly, in some aspects, intake of the fire retarding solution 200 into the fiber product 100 through the surface 105 thereof may be facilitated by saturating the surface 105 of the fiber product 100 with the fire retarding solution 200, or otherwise exposing the surface 105 of the fiber product 100 to the fire retarding solution 200, prior to processing the fiber product 100 through the first and second nips 400, 500. Accordingly, in some aspects (see, e.g., FIG. 1), the apparatus 300 may comprise a first container 600 configured to receive the fiber product 100 such that the fiber product 100 is submerged in the fire retarding solution 200 prior to being received through the first nip 400. The time period for holding the fiber product 100 in the first container (“dip tank”) 600 may vary, for example, from seconds to minutes to hours to days. If a plurality of fiber products 100 is received by the first container 600, the fiber products 100 may be arranged to be spaced apart (i.e., by using spacers, racks, or any other suitable mechanism for keeping the fiber products 100 spaced apart) such that the fire retarding solution 200 is able to wet substantially all of the surface of the fiber product 100.

In some instances, particularly where the first and second nips 400, 500 are submerged in the fire retarding solution 200, the apparatus 300 may further comprise a second container 700 configured to receive the first nip 400 and the second nip 500 therein. That is, the second container 700 may be configured to hold both the first and second nips 400, 500 in such a manner that the fiber product 100 can be received in the second container 700 and processed through the first and second nips 400, 500, while being submerged in the fire retarding solution 200, as previously disclosed. In some instances, it may be preferable for the second container 700 to be configured and arranged to be in fluid communication with the first container 600 so as to allow the fiber product 100 to be directed from the first container 600 to the second container 700 while maintaining the fiber product 100 submerged in the fire retarding solution 200. That is, the first and second containers 600, 700 may be configured such that the fiber product 100 received by the first container 600 and submerged in the fire retarding solution 200, is not removed from the fire retarding solution 200 during transfer to the second container 700 or during processing through the first and second nips 400, 500. One skilled in the art will appreciate that the fluidly-connected first and second containers 600, 700 may further require the apparatus 300 to include an appropriate arrangement (not shown, but i.e., a conveyor system or robotized mechanism) for moving the fiber product 100 from the first container 600 and into the second container 700 into engagement with at least the first nip 400. In some instances, once the fiber product 100 is deposited in the first container 600 (and once the fiber product 100 is removed from the second container 700), it may be desirable for the first and/or second containers 600, 700 to be configured to be sealable, so as to minimize evaporation of the fire retarding solution 200 before, during, or after processing of the fiber product 100.

Because the fiber product 100 processed by aspects of the present disclosure may vary considerably in dimension (i.e., the thickness thereof may be considerable or otherwise material in comparison to the width), there may be instances in which it may be necessary or desirable to also process the side surfaces 110 of the fiber product 100 so as to provide a more complete and effective treatment of the fiber product 100 with the fire retarding solution 200. As such, in some instances (see, e.g., FIG. 2), the apparatus 300 may further include a third nip 750 defined by a pair of juxtaposed processing members 755, 760 each having a processing surface 770 (see, e.g., FIG. 2), and configured to receive the fiber product 100 therethrough. The third nip 750 may be oriented perpendicularly to the first nip 400 and may be disposed prior to the second nip 500. That is, the third nip 750 may be disposed and arranged prior to, in conjunction with, or following the first nip 400, but before the second nip 500. In such instances, at least one of the processing members 755, 760 of the second nip 750 comprises at least one incisor member 765 extending from the processing surface 770 thereof and configured to interact with and alter a corresponding surface 110 of the fiber product 100 directed through the third nip 750, in a similar manner to the similarly configured and arranged first nip 400. Thus, for brevity, the particular details of the third nip 750 are not separately addressed herein. Likewise, in instances where the thickness of the fiber product 100 is considerable or material, the apparatus 300 may further comprise a fourth nip 800 (see, e.g., FIG. 3) defined by a pair of juxtaposed compression members 805, 810 each having a compression surface 820 (see, e.g., FIG. 3) and configured to receive the fiber product 100 therethrough. The fourth nip 800 may be oriented perpendicularly to the second nip 500 and may be disposed subsequent to the first nip 400. That is, the fourth nip 800 may be disposed and arranged prior to, in conjunction with, or following the second nip 500, but after the first nip 400. As with the similarly configured and arranged second nip 500, the compression surfaces 820 of the compression members 805, 810 may be configured to cooperate to compress the surface 110 of the fiber product 100 within an elastic range (or otherwise within a nondestructive range) associated therewith, wherein the fourth nip 800 may be disposed in the fire retarding solution 200 such that the fiber product 100 is submerged in the fire retarding solution 200 at least upon exiting the fourth nip 800. Thus, for brevity, the particular details of the fourth nip 800 are not separately addressed herein.

Because the surface area of the fiber product 100 may be large in comparison to the interaction of the first and/or third nips 400, 750 therewith, it may be necessary or desirable, in some instances, to further process the surfaces 105, 110 of the fiber product 100 in order to facilitate a more even and uniform treatment of the fiber product 100 with the fire retarding solution 200. In such instances, the apparatus 300 may further comprise a fifth nip 850 (see, e.g., FIG. 1) defined by a pair of juxtaposed processing members 855, 860 each having a corresponding processing surface and configured to receive the fiber product 100 therethrough from the second nip 500, wherein at least one of the processing members 855, 860 may comprise at least one incisor member 865 extending from the processing surface thereof and configured to interact with and alter the surface 105 of the fiber product 100 directed through the fifth nip 850. That is, following processing of the fiber product 100 through the second nip 500, the fiber product 100 may again be directed through a fifth nip 850 configured in a similar manner to the first nip 400 (and optionally through a seventh nip (not shown) configured and arranged perpendicularly to the fifth nip 850, in a similar manner to the third nip 750), to possibly interact with portions of the surface 105 of the fiber product 100 not previously processed in the first nip 400.

In some aspects, it may thus follow that the apparatus 300 also includes a sixth nip 900 (see, e.g., FIG. 1) defined by a pair of juxtaposed compression members 905, 910 each having a compression surface, and configured to receive the fiber product 100 therethrough from the fifth nip 850, wherein the compression surfaces of the compression members 905, 910 may be configured to cooperate to compress the surface 105 of the fiber product 100 within the elastic range associated therewith, and wherein the sixth nip 900 may be disposed in the fire retarding solution 200 such that the fiber product 100 is submerged in the fire retarding solution 200 at least upon exiting the sixth nip 900. That is, following processing of the fiber product 100 through the fifth nip 850, the fiber product 100 may again be directed through a sixth nip 900 configured in a similar manner to the second nip 500 (and optionally through an eighth nip (not shown) configured and arranged perpendicularly to the sixth nip 900, in a similar manner to the fourth nip 800), to interact with the surface 105 of the fiber product 100 to again facilitate and promote intake of the fire retarding solution 200 into the fiber product 100 through the surface 105 thereof.

Of course, one skilled in the art will appreciate that any amount of successive nips may be provided in connection with the apparatus 300 so as to further process the surface(s) of the fiber product 100, followed by compression and expansion, so as to encourage and facilitate intake of the fire retarding solution 200 by and penetration into the fiber product 100 through the surfaces 105, 110 thereof. In addition, one skilled in the art will also appreciate that it may be desirable or necessary to keep the fiber product 100 submerged in the fire retarding solution 200 throughout the processing of the fiber product 100 through the varied number of subsequent nips which may be implemented to process the fiber product 100.

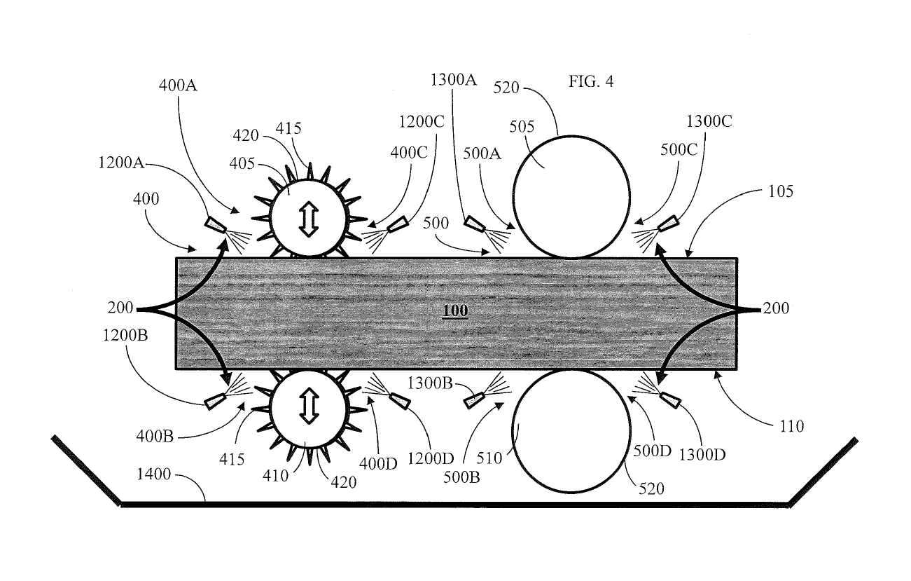

In some aspects of the present disclosure as shown, for example, in FIG. 4, non-submerged flooded nips may be implemented, instead of submerging the fiber product 100/nips in the fire retarding solution 200, as the fiber product 100 is directed through the first nip 400, the second nip 500, and any additional nips. More particularly, when viewed in cross-section as shown in FIG. 4, each nip 400, 500 through which the fiber product 100 is directed can be divided into quadrants, namely a first (i.e., about the upper surface of the fiber product 100) quadrant 400A and a second (i.e., about the lower surface of the fiber product 100) quadrant 400B upon the fiber product 100 entering the nip 400, 500 and engaging the roller elements 405, 410 thereof, and a first (i.e., upper) quadrant 400C and a second (i.e., lower) quadrant 400D upon the fiber product 100 exiting the nip 400, 500 and disengaging the roller elements 405, 410 thereof. In such aspects, the treatment chemical (i.e., the fire retarding solution 200) may be directed to or otherwise provided at the nip 400, 500 to form a “flooded nip” at either or both quadrants 400A, 400B, 500A, 500B of the nip entrance and/or at either or both quadrants 400C, 400D, 500C, 500D of the nip exit. In one instance, at least the entrance to the first nip 400 formed by juxtaposed processing members 405, 410 may have both the top and bottom quadrants 400A, 400B flooded with the fire retarding solution 200 by respective nozzle arrangements 1200A, 1200B during processing of the fiber product 100 through the first nip 400.

During processing of the fiber product 100 through the first nip 400, flooding the entrance and/or exit of the first nip 400 with the fire retarding solution 200 may allow for some absorption of the fire retarding solution 200 by the surface layer of the fiber product 100. Because the first nip 400 is flooded, upon the incisor(s) 415 of at least one of the processing members 405, 410 being physically forced or urged into engagement with the surface layer of the fiber product 100 (lumber), the penetrating incisor(s) (incisor member 415) may at least partially force or urge the fire retarding solution 200 into the incised cavity formed by each incisor member 415. In some instances, the depth of penetration of each incisor member 415 into the surface layer of the fiber product 100 may be regulated according to the size (i.e., length or depth) of the particular incisor member 415. In some instances, the processing surfaces 420 of the respective processing member 405, 410 from which the incisor(s) 415 protrude or extend may each comprise a smooth cylindrical surface (i.e., in the manner of a cylindrical roller element). As such, in some aspects, a processing member/roller element 405, 410 configured in this manner may also function as a compression member (i.e., via the processing surfaces 420), as well as an incising member (i.e., via the at least one incisor member 415). With such incision/compression members 405, 410, as the one or more incisor elements 415 penetrate the surface layer of the fiber product 100 entering the flooded first nip 400, the smooth cylindrical processing surfaces 420 also compress the surface layer of the fiber product 100 to force or urge the fire retarding solution 200 into the surface layer.

That is, compressing the surface layer of the fiber product 100, within an elastic or nondestructive force limit, compresses air out of the cell structures about the surface layer (i.e., of the lumber having the surface layer rendered pliable by “pre-soaking”). Since the first nip 400 is flooded, the smooth cylindrical processing surfaces 420 of the processing members 405, 410 may also cooperate and function to force or urge the fire retarding solution 200 into the surface layer of the fiber product 100, while air trapped or retained in the surface layer is expelled. This compression of the surface layer may remove a portion of the fire retarding solution 200 penetrating the surface layer. However, as the fiber product 100 passes through and exits the first nip 400 by disengaging the processing elements 405, 410, the decompression of the fiber product 100 may cause the fiber product 100 to re-absorb additional amounts of the fire retarding solution 200 (i.e., in a sponge-type effect). In some instances, as the fiber product 100 exits the first nip 400, one or both quadrants 400C, 400D about the nip exit may also be flooded with the fire retarding solution 200 by respective nozzle arrangements 1200C, 1200D so as to supply the de-compressing fiber product 100 exiting the first nip 400 with additional amounts of the fire retarding solution 200 for facilitating the absorption thereof by the fiber product 100 due to the sponge-type effect. A “localized pressure” (and expansion) treatment protocol using a physical force acting directly on the fiber product via the respective nip is thus effected in order to impregnate or otherwise cause absorption or penetration of the surface of fiber product (i.e., lumber) with an appropriate or desired chemical treatment such as the fire retarding solution, wherein the absorption/treatment is enhanced by the physical manipulation (i.e., the “sponge effect”) over treatment methods lacking the localized compression/expansion of the surface of the fiber product.

In some aspects, following the first nip 400, a similar process may be repeated in regard to a second nip 500 (or in regard to any other nips in the treatment process as disclosed herein) formed by juxtaposed smooth compression members 505, 510 (i.e., compression rollers) each having a substantially smooth compression surface 520 (see, e.g., FIG. 4), wherein the second nip entrance quadrants 500A, 500B and/or second nip exit quadrants 500C, 500D may be flooded with the fire retarding solution 200 by respective nozzle arrangements 1200A, 1200B, 1200C, 1200D, and the fiber product 100 being compressed upon entering the second nip 500 and then being allowed to de-compress upon exiting the second nip 500. The smooth compression members/rollers 505, 510 in the second nip 500 implements the applied compression via cooperation of the compression surfaces 520 to further force or urge the fire retarding solution 200 into the cavities or incisions created in the fiber product 100 in the first nip 400. In some aspects, the fiber product 100 may be directed through one or more subsequent nips, as necessary or desired, to further facilitate penetration or absorption of the fire retarding solution 200 into the fiber product 100, wherein such subsequent nips may be flooded using appropriate nozzle arrangements as otherwise disclosed herein.

One result of the flooded nip configuration disclosed herein is that excess amounts of the fire retarding solution 200 may be dispensed with respect to the series of nips comprising the treatment process. As such, in some aspects, one or more recovery basins 1400 may be provided and disposed under all of the nips, collectively or individually, wherein any excess fire retarding solution 200 can be collected in the recovery basin(s) 1400 for recycling back into the treatment process disclosed herein (i.e., to be used in the “pre-soak” of the fiber product 100 in the first container 600, in the first and/or second containers 600, 700 for keeping the fiber product submerged during the treatment process, and/or in the flooded nips), or otherwise for proper and appropriate disposal.

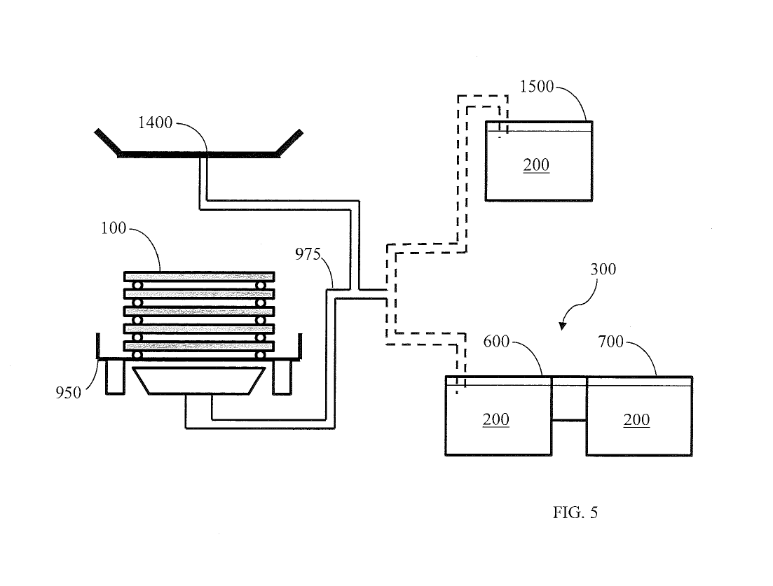

In some aspects, once the fiber product 100 has been treated with the fire retarding solution 200 in any of the disclosed manners and/or after removal thereof from the second container 700 or upon exit from the final nip in the treatment process, the apparatus 300 may further comprise a de-liquefying arrangement 950 (see, e.g., FIG. 5) configured to receive and de-liquefy the fiber product 100. In some instances, the de-liquefying arrangement 950 may comprise a rack configured to receive the fiber product(s) 100 and to hold the fiber product(s) 100 in a separated and spaced-apart manner so as to allow any excess fire retarding solution 200 to drain therefrom (i.e., allow the fiber product 100 to dry). In other instances, the de-liquefying process may be facilitated by providing, as necessary or desired, a dryer (in addition to or in the alternative to the rack), as will be appreciated by one skilled in the art, to form the dry fire retardant-treated fiber product 100. In one aspect, the dryer may be configured to apply heat to the wet fiber product 100, for example, via heated and/or circulated air (i.e., air heated with combusted natural gas or other suitable fuel source), or through any of a variety of heating/de-liquefying/drying methods, such as, for example, microwave or infrared drying techniques, as will be appreciated by one skilled in the art. In other instances, the dryer may be configured to provide circulated air, without the addition of heat.

In some aspects, the apparatus 300 may also comprise a recovery device 975 (see, e.g., FIG. 5) configured to recover excess fire retarding solution, in one of a liquid and a vapor form, upon the de-liquefying arrangement 950 receiving and de-liquefying the fiber product 100 and/or from the recovery basin(s) 1400. In some instances, the recovery device 975 may also be configured to engage the first and/or second containers 600, 700 for accomplishing the recovery of the excess fire retarding solution 200. That is, the recovery device 975 may be configured to direct the recovered excess fire retarding solution 200, removed from the fiber product(s) upon de-liquefaction thereof by the de-liquefying arrangement 950, to the first and/or second containers 600, 700, for example, in a closed-loop, fire retarding solution recycling process. In other instances, the recovery device 975 may also be configured to engage the recovery basin(s) 1400 for recovering excess fire retarding solution 200 used to flood the nips, and to direct the recovered excess fire retarding solution 200 to a reservoir 1500, for example, in a closed-loop, fire retarding solution recycling process. The reservoir 1500 may be, for example, in communication with the nozzle arrangements used to flood the nips (i.e., nozzle arrangements 1200A-D and 1300A-D) with the fire retarding solution 200. Upon recovery of the excess portions, including liquids and vapors, by the recovery device 975, the recovered excess fire retarding solution may be strained, filtered, or otherwise purified, and then reintroduced to the first and/or second containers 600, 700 or the nozzle arrangements 1200A-D and 1300A-D, for processing subsequent fiber products 100, and such that the fire retarding solution 200 is substantially or entirely prevented from leaving the apparatus 300 as a waste product.

The fiber product treatment apparatuses and methods disclosed herein as representing various aspects of the present disclosure, may exhibit, for example, a significant tolerance of variability in the feed rate of the fiber product therethrough that is required to provide and maintain effective application of the chemical treatment to the fiber product units, as well as consistency in the treatment across the units of the fiber product. For example, the penetration/absorption of the chemical treatment into the fiber product may be similar at a feed rate of the fiber products of 20 feet per minute as at a feed rate of 200 feet per minute. As such, unit volume output by the fiber product treatment apparatuses and methods disclosed herein may be increased, for instance, by a factor of 10 or more compared to a pressure treatment using single charge pressure vessels, thereby resulting, for example, in lower production costs and greater profitability.

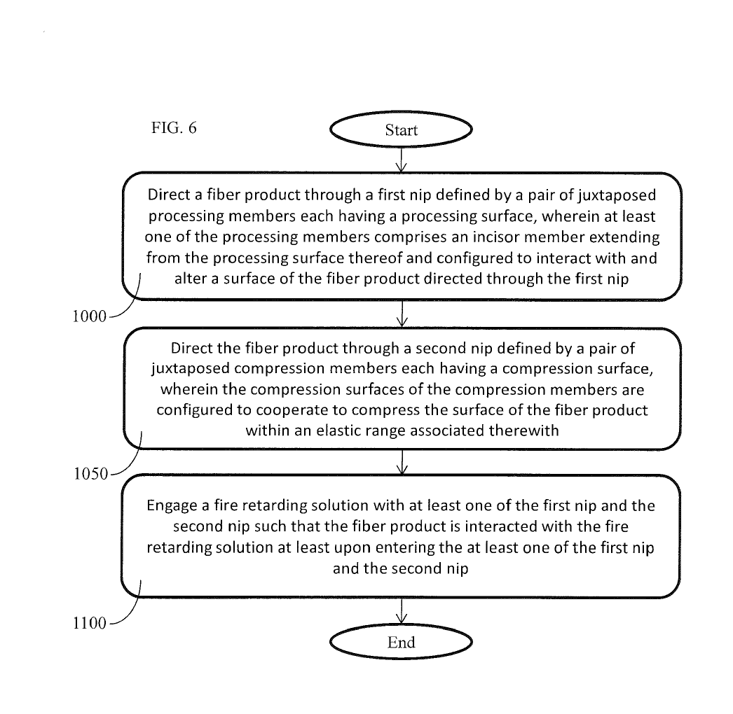

Many modifications and other aspects of the disclosures set forth herein will come to mind to one skilled in the art to which these disclosures pertain having the benefit of the teachings presented in the foregoing descriptions and the associated drawings. For example, one skilled in the art that the apparatuses disclosed herein readily lead to associated processes and methods for forming a fire retardant-treated fiber product, as shown, for example, in FIG. 6. More particularly, such methods may comprise directing a fiber product through a first nip defined by a pair of juxtaposed processing members each having a processing surface, wherein at least one of the processing members comprises an incisor member extending from the processing surface thereof and configured to interact with and alter a surface of the fiber product directed through the first nip (block 1000); directing the fiber product through a second nip defined by a pair of juxtaposed compression members each having a compression surface, wherein the compression surfaces of the compression members are configured to cooperate to compress the surface of the fiber product within an elastic range associated therewith (block 1050); and engaging a fire retarding solution with at least one of the first nip and the second nip such that the fiber product is interacted with the fire retarding solution at least upon entering the at least one of the first nip and the second nip (block 1100).

In addition, in some instances, the first and/or second containers 600, 700 may be configured to receive other appropriate substances/materials/chemicals for treating the fiber products. For example, the first and/or second containers 600, 700 may be configured to receive a mold inhibitor; an insect repellant or insecticide, a water repellant, waterproofing, and/or otherwise water resistant substance, or combinations thereof, for treating the fiber product in addition to or instead of the fire retarding treatment.

Therefore, it is to be understood that the disclosures are not to be limited to the specific aspects disclosed and that modifications and other aspects are intended to be included within the scope of the appended claims. Although specific terms are employed herein, they are used in a generic and descriptive sense only and not for purposes of limitation.

1. A method of forming a fire retardant-treated fiber product, said method comprising:
directing a fiber product having opposed surfaces through a first nip defined by a pair of juxtaposed processing members each having a processing surface, each processing member comprising an incisor member extending from the processing surface thereof and configured to interact with and penetrate one of the opposed surfaces of the fiber product directed through the first nip, and the processing surfaces of the processing members of the first nip being configured to cooperate to elastically compress the surface of the fiber product;
directing the fiber product through a second nip defined by a pair of juxtaposed compression members each having a compression surface, the compression surfaces of the compression members being configured to cooperate to elastically compress the surface of the fiber product; and
engaging a fire retarding solution with at least one of the first nip such that the fiber product is interacted with the fire retarding solution at least upon entering at least the first nip.

2. A method according to claim 1, wherein engaging a fire retarding solution with at least the first nip further comprises submerging at least the first nip in the fire-retarding solution.

3. A method according to claim 1, wherein engaging a fire retarding solution with at least the first nip further comprises one of directing the fire retarding solution toward an entrance of at least the first nip such that the fire retarding solution interacts with at least one of the opposed surfaces of the fiber product upon engagement thereof with the corresponding one of the processing members or the compression members, and directing the fire retarding solution toward an exit of at least the first nip such that the fire retarding solution interacts with at least one of the opposed surfaces of the fiber product upon disengagement thereof from the corresponding one of the processing members and the compression members.

4. A method according to claim 1, further comprising submerging the fiber product in the fire retarding solution prior to directing the fiber product through the first nip, and optionally maintaining the fiber product submerged in the fire retarding solution for a selected time period prior to directing the fiber product through the first nip.

5. (canceled)

6. A method according to claim 1, wherein the first nip is disposed in the fire retarding solution, and directing a fiber product further comprises directing a fiber product through the first nip such that the fiber product is submerged in the fire retarding solution at least upon exiting the first nip.

7. A method according to claim 1, wherein the first and second nips are disposed in the fire retarding solution, and directing the fiber product through the first and second nips further comprises directing the fiber product through the first and second nips such that the fiber product is continually submerged in the fire retarding solution from prior to the first nip through subsequent to the second nip.

8. A method according to claim 4, wherein submerging the fiber product in the fire retarding solution comprises submerging the fiber product in the fire retarding solution in a first container and directing the fiber product through the first nip comprises directing the fiber product through the first nip in a second container, and the method further comprises directing the fiber product from the first container to the second container while maintaining the fiber product submerged in the fire retarding solution, and optionally sealing the first and second containers upon receiving the fiber product in the first container so as to minimize evaporation of the fire retarding solution.

9. A method according to claim 1, further comprising directing the fiber product through a third nip defined by a pair of juxtaposed processing members each having a processing surface, the third nip being oriented perpendicularly to the first nip and being disposed prior to the second nip, wherein each processing member comprises an incisor member extending from the processing surface thereof and configured to interact with and penetrate a corresponding surface of the fiber product directed through the third nip and the processing surfaces of the processing members of the third nip are configured to cooperate to elastically compress the surface of the fiber product.

10. (canceled)

11. A method according to claim 9, further comprising one of directing the fire retarding solution toward an entrance of the third nip such that the fire retarding solution interacts with at least one of the corresponding surfaces of the fiber product upon engagement thereof with the processing members, and directing the fire retarding solution toward an exit of the third nip such that the fire retarding solution interacts with at least one of the corresponding surfaces of the fiber product upon disengagement thereof from the processing members.

12. A method according to claim 1, further comprising directing the fiber product through a fourth nip defined by a pair of juxtaposed compression members each having a compression surface, the fourth nip being oriented perpendicularly to the second nip and being disposed subsequent to the first nip, wherein the compression surfaces of the compression members are configured to cooperate to elastically compress the surface of the fiber product.

13. A method according to claim 12, further comprising one of directing the fire retarding solution toward an entrance of the fourth nip such that the fire retarding solution interacts with at least one of the corresponding surfaces of the fiber product upon engagement thereof with the compression members, and directing the fire retarding solution toward an exit of the fourth nip such that the fire retarding solution interacts with at least one of the corresponding surfaces of the fiber product upon disengagement thereof from the compression members.

14. A method according to claim 1, wherein each processing member comprises a plurality of incisor members extending from the processing surface and arranged across a width thereof, and directing a fiber product through a first nip further comprises directing the fiber product through the first nip to interact the plurality of incisor members with the fiber product across a width thereof and to penetrate the surface of the fiber product across the width and along a length thereof.

15. (canceled)

16. A method according to claim 1, further comprising directing the fiber product from the second nip through a fifth nip defined by a pair of juxtaposed processing members each having a processing surface, each processing member comprising an incisor member extending from the processing surface thereof and configured to interact with and penetrate a surface of the fiber product directed through the fifth nip, and optionally directing the fiber product from the fifth nip through a sixth nip defined by a pair of juxtaposed compression members each having a compression surface, the compression surfaces of the compression members being configured to cooperate to elastically compress the surface of the fiber product.

17. A method according to claim 1, wherein engaging a fire retarding solution with at least one of the first nip and the second nip further comprises engaging a fire retarding solution with at least one of the first nip and the second nip, wherein the fire retarding solution comprises one of a boron compound, a phosphorus compound, a chlorine compound, a fluorine compound, an antimony compound, a borate compound, a halogen compound, boric acid, an inorganic hydrate, a bromine compound, aluminum hydroxide, magnesium hydroxide, hydromagnesite, antimony trioxide, a phosphonium salt, ammonium phosphate, diammonium phosphate, methyl bromide, methyl iodide, bromochlorodifluoromethane, dibromotetrafluoroethane, dibromodifluoromethane, carbon tetrachloride, urea-potassium bicarbonate, and combinations thereof.

18. A method according to claim 1, further comprising de-liquefying the fiber product subsequent to the second nip.

19. A method according to claim 1, wherein engaging a fire retarding solution with at least one of the first nip and the second nip further comprises engaging a fire retarding solution with at least one of the first nip and the second nip, wherein the fire retarding solution comprises one of an aqueous fire retarding solution, a nontoxic liquid fire retarding solution, and a neutral pH liquid fire retarding solution.

20. An apparatus for forming a fire retardant-treated fiber product, said apparatus comprising:
a first nip defined by a pair of juxtaposed processing members each having a processing surface, the first nip being configured to receive a fiber product therethrough, each processing member comprising an incisor member extending from the processing surface thereof and configured to interact with and penetrate a surface of the fiber product directed through the first nip, and the processing surfaces of the processing members of the first nip being configured to cooperate to elastically compress the surface of the fiber product; and
a second nip defined by a pair of juxtaposed compression members each having a compression surface, the second nip being configured to receive the fiber product therethrough, the compression surfaces of the compression members being configured to cooperate to elastically compress the surface of the fiber product, at least one of the first nip and the second nip being arranged to receive a fire retarding solution such that the fiber product is interacted with the fire retarding solution at least upon entering the at least one of the first nip and the second nip.

21. An apparatus according to claim 20, wherein the at least one of the first nip and the second nip is arranged to be submerged in the fire-retarding solution.

22. An apparatus according to claim 20, wherein the at least one of the first nip and the second nip is arranged to one of receive the fire retarding solution about an entrance thereof such that the fire retarding solution interacts with at least one of the opposed surfaces of the fiber product upon engagement thereof with the corresponding one of the processing members or the compression members, and receive the fire retarding solution about an exit thereof such that the fire retarding solution interacts with at least one of the opposed surfaces of the fiber product upon disengagement thereof from the corresponding one of the processing members and the compression members.

23. (canceled)

24. An apparatus according to claim 20, wherein the first nip is disposed in the fire retarding solution such that the fiber product is submerged in the fire retarding solution at least upon exiting the first nip.

25. An apparatus according to claim 20, wherein the first and second nips are disposed in the fire retarding solution such that the fiber product is continually submerged in the fire retarding solution from prior to the first nip through subsequent to the second nip.

26. An apparatus according to claim 20, further comprising a first container configured to receive the fiber product such that the fiber product is submerged in the fire retarding solution prior to being received through the first nip, and optionally further comprising a second container configured to receive the first nip and the second nip therein, the second container being in fluid communication with the first container to allow the fiber product to be directed from the first container to the second container while maintaining the fiber product submerged in the fire retarding solution, and optionally wherein the first and second containers are configured to be sealable upon the fiber product being received in the first container so as to minimize evaporation of the fire retarding solution.

27. An apparatus according to claim 20, further comprising a third nip defined by a pair of juxtaposed processing members each having a processing surface and being configured to receive the fiber product therethrough, the third nip being oriented perpendicularly to the first nip and being disposed prior to the second nip, wherein each processing member comprises an incisor member extending from the processing surface thereof and configured to interact with and penetrate a corresponding surface of the fiber product directed through the third nip, and wherein the processing surfaces of the processing members of the third nip are further configured to cooperate to elastically compress the surface of the fiber product.

28. An apparatus according to claim 27, wherein the third nip is arranged to one of receive the fire retarding solution about an entrance thereof such that the fire retarding solution interacts with at least one of the corresponding surfaces of the fiber product upon engagement thereof with the processing members, and receive the fire retarding solution about an exit thereof such that the fire retarding solution interacts with at least one of the corresponding surfaces of the fiber product upon disengagement thereof from the processing members.

29. An apparatus according to claim 20, further comprising a fourth nip defined by a pair of juxtaposed compression members each having a compression surface and being configured to receive the fiber product therethrough, the fourth nip being oriented perpendicularly to the second nip and being disposed subsequent to the first nip, wherein the compression surfaces of the compression members are configured to cooperate to elastically compress the surface of the fiber product.

30. An apparatus according to claim 29, wherein the fourth nip is arranged to one of receive the fire retarding solution about an entrance thereof such that the fire retarding solution interacts with at least one of the corresponding surfaces of the fiber product upon engagement thereof with the compression members, and receive the fire retarding solution about an exit thereof such that the fire retarding solution interacts with at least one of the corresponding surfaces of the fiber product upon disengagement thereof from the compression members.

31. An apparatus according to claim 20, wherein each processing member comprises a plurality of incisor members extending from the processing surface and arranged across a width thereof, the plurality of incisor members being configured to interact with the fiber product across a width thereof and to penetrate the surface of the fiber product across the width and along a length thereof.

32. An apparatus according to claim 20, further comprising a fifth nip defined by a pair of juxtaposed processing members each having a processing surface and being configured to receive the fiber product therethrough from the second nip, each processing member comprising an incisor member extending from the processing surface thereof and configured to interact with and penetrate a surface of the fiber product directed through the fifth nip, and further comprising a sixth nip defined by a pair of juxtaposed compression members each having a compression surface and being configured to receive the fiber product therethrough from the fifth nip, the compression surfaces of the compression members being configured to cooperate to elastically compress the surface of the fiber product.

33. An apparatus according to claim 20, wherein the fire retarding solution comprises one of a boron compound, a phosphorus compound, a chlorine compound, a fluorine compound, an antimony compound, a borate compound, a halogen compound, boric acid, an inorganic hydrate, a bromine compound, aluminum hydroxide, magnesium hydroxide, hydromagnesite, antimony trioxide, a phosphonium salt, ammonium phosphate, diammonium phosphate, methyl bromide, methyl iodide, bromochlorodifluoromethane, dibromotetrafluoroethane, dibromodifluoromethane, carbon tetrachloride, urea-potassium bicarbonate, and combinations thereof.

34. An apparatus according to claim 20, further comprising a de-liquefying arrangement configured to receive and de-liquefy the fiber product subsequent to the second nip.

35. An apparatus according to claim 20, wherein the fire retarding solution comprises one of an aqueous fire retarding solution, a nontoxic liquid fire retarding solution, and a neutral pH liquid fire retarding solution.
